(19) United States
(12) Patent Application Publication
(10) Pub. No.: US 2009/0262462 A1
(43) Pub. Date: Oct. 22, 2009

(54) STORAGE APPARATUS

(75) Inventor: Hiroshi Kobayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/328,393

(22) Filed: Dec. 4, 2008

(30) Foreign Application Priority Data
Apr. 16, 2008 (JP) 2008-107229

(51) Int. Cl. G11B 5/55

(52) U.S. Cl. 360/266.5; G9B/5.182

(57) ABSTRACT

A carriage block body is coupled to a support shaft for relative rotation. The carriage block body defines a bearing hole receiving the support shaft. A carriage arm extends from the carriage block body along an imaginary plane perpendicular to the longitudinal axis of the support shaft. The carriage arm has a wall surface defining a cylindrical space at the tip end of the carriage arm. A projection is formed on the wall surface at a position off an intermediate plane set perpendicular to the longitudinal axis of the cylindrical space so that the cylindrical space is equally divided into a first cylindrical space and a second cylindrical space by the intermediate plane. The projection protrudes into the first cylindrical space.

### CROSS-REFERENCE TO RELATED APPLICATION

This application is based upon and claims the benefit of priority from the prior Japanese Patent Application No. 2008-107229 filed on Apr. 16, 2008, the entire contents of which are incorporated herein by reference.

### BACKGROUND

1. Field

The present invention relates to a carriage block incorporated in a storage apparatus such as a hard disk drive, HDD, for example.

2. Description of the Prior Art

A carriage is incorporated in a hard disk drive, HDD. The carriage includes a carriage block. The carriage block includes a carriage block body and a carriage arm. The carriage block body is coupled to a support shaft for relative rotation. The carriage arm extends forward from the tip end of the carriage block. A head suspension is attached to the tip end of the carriage arm. A head slider is fixed to the tip end of the head suspension.

Assume that two magnetic recording disks are incorporated in the hard disk drive, for example. The carriage arm is opposed to the back surface of the upper magnetic recording disk and the front surface of the lower magnetic recording disk between the magnetic recording disks. Two head suspensions are attached to the front and back surfaces of the carriage arm between the magnetic recording disks. In this manner, head sliders are respectively opposed to the back surface of the upper magnetic recording disk and the front surface of the lower magnetic recording disk between the magnetic recording disks.

A cylindrical boss is formed in a base plate of the head suspension for attachment of the head suspension to the carriage arm. The cylindrical boss is received in a caulking hole defined in the carriage arm. The boss stands upright from the surface of the base plate. A metallic ball is pushed into the boss in the caulking process. The metallic ball serves to urge the boss against the inner wall surface of the caulking hole. The boss is forced to plastically deform. The head suspension is in this manner fixed to the carriage arm.

The head suspensions are respectively attached to the front and back surfaces of the carriage arm between the magnetic recording disks as described above. The inner surface of the caulking hole is allowed to receive stress equally at the front side and the back side of the carriage arm during the plastic deformation of the boss. On the other hand, the head suspension is attached to the back surface of the top one of the carriage arms. The head suspension is also attached to the front surface of the bottom one of the carriage arms. In these cases, the inner surface of the caulking hole is forced to receive stress unevenly at the front side and the back side of the carriage arm based on the plastic deformation of the boss. Such unevenness of the stress results in an unexpected deformation or warp of the carriage arm. The actual flying height of the flying head slider deviates from a designed flying height.

### SUMMARY

According to an aspect of an embodiment, a storage apparatus includes: a carriage block body coupled to a support shaft for relative rotation, the carriage block body defining a bearing hole receiving the support shaft; a carriage arm extending from the carriage block body along an imaginary plane perpendicular to the longitudinal axis of the support shaft, the carriage arm having a wall surface defining a cylindrical space at the tip end of the carriage arm; and a projection formed on the wall surface at a position off an intermediate plane, the intermediate plane set perpendicular to the longitudinal axis of the cylindrical space so that the cylindrical space is equally divided into a first cylindrical space and a second cylindrical space by the intermediate plane, the projection protruding into the first cylindrical space.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive, HDD, as a specific example of a storage apparatus according to the present invention;

FIG. 2 is a plan view schematically illustrating a head suspension;

FIG. 3 is a partial sectional view schematically illustrating a carriage;

FIG. 4 is an enlarged partial sectional view schematically illustrating a carriage arm and the head suspension;

FIG. 5 is a partial sectional view schematically illustrating the process of attaching the head suspension to the carriage arm;

FIG. 6 is an enlarged partial sectional view schematically illustrating a carriage block according to a first embodiment of the present invention;

FIG. 7 is a partial sectional view schematically illustrating the process of pushing a metallic ball into a caulking hole;

FIG. 8 is an enlarged partial sectional view schematically illustrating the carriage arm and the head suspension;

FIG. 9 is an enlarged partial sectional view schematically illustrating a carriage block according to a second embodiment of the present invention;

FIG. 10 is an enlarged partial sectional view schematically illustrating the carriage arm and the head suspension; and

FIG. 11 is an enlarged partial sectional view schematically illustrating a carriage block according to a third embodiment of the present invention.

### DESCRIPTION OF EMBODIMENTS

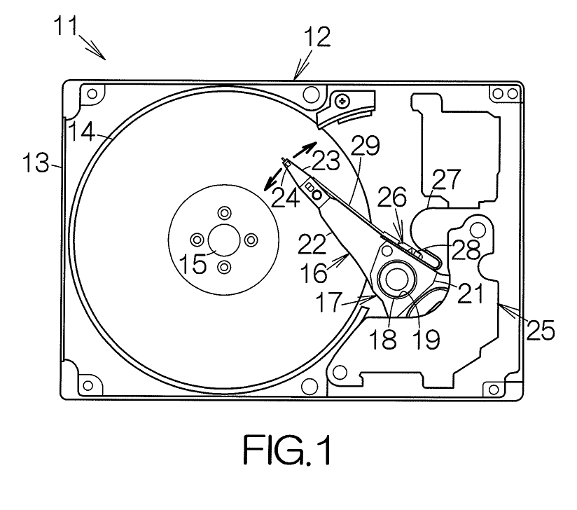

FIG. 1 schematically illustrates the structure of a hard disk drive, HDD, 11 as an example of a storage medium drive or a storage apparatus according to the present invention. The hard disk drive 11 includes an enclosure 12. The enclosure 12 includes a box-shaped base 13 and a cover, not shown. The base 13 defines an inner space in the form of a flat parallelepiped, for example. The base 13 may be made of a metallic material such as aluminum, for example. Molding process may be employed to form the base 13. The cover is coupled to the opening of the base 13. A sealed inner space is defined between the base 13 and the cover. Pressing process may be employed to form the cover out of a plate material, for example.

At least one magnetic recording disk 14 as a storage medium is enclosed in the enclosure 12. Here, two magnetic recording disks 14 are enclosed in the enclosure 12, for example. The magnetic recording disks 14 are mounted on the driving shaft of a spindle motor 15. The spindle motor 15 drives the magnetic recording disks 14 at a higher revolution speed such as 5,400 rpm, 7,200 rpm, 10,000 rpm, 15,000 rpm, or the like.

A carriage 16 is also enclosed in the enclosure 12. The carriage 16 includes a carriage block 17. The carriage block 17 includes a carriage block body 21 having a bearing hole 19 formed therein. A vertical support shaft 18 is received in the bearing hole 19 so that the carriage block 17 is coupled to the vertical support shaft 18 for relative rotation. The carriage block body 21 includes three carriage arms 22 extending along corresponding imaginary planes perpendicular to the longitudinal axis of the vertical support shaft 18. Each of the front and back surfaces of the magnetic recording disks 14 is related to any single one of the carriage arms 22. The carriage block 17 may be made of a metallic material such as aluminum, for example. The carriage block 17 may be molded based on sintering process, for example.

A head suspension 23 is fixed to the tip end of the individual carriage arm 22. The head suspension 23 extends forward from the tip end of the carriage arm 22. Two head suspensions 23 are attached to the middle one of the carriage arms 22 between the magnetic recording disks 14. One head suspension 23 is attached to each of the top and bottom ones of the carriage arms 22. A flying head slider 24 is fixed to the tip end of the individual head suspension 23. A head element or electromagnetic transducer, not shown, is mounted on the flying head slider 24.

When the magnetic recording disk 14 rotates, the flying head slider 24 is allowed to receive airflow generated along the rotating magnetic recording disk 14. The airflow serves to generate a positive pressure or a lift as well as a negative pressure on the flying head slider 24. The lift is balanced with the negative pressure and the urging force of the head suspension so that the flying head slider 24 is allowed to keep flying above the surface of the magnetic recording disk 14 during the rotation of the magnetic recording disk 14 at a relatively high stability.

When the carriage 16 is driven to swing about the vertical support shaft 18 during the flight of the flying head slider 24, the flying head slider 24 is allowed to move along the radial direction of the magnetic recording disk 14. This radial movement allows the electromagnetic transducer on the flying head slider 24 to cross the data zone between the innermost recording track and the outermost recording track. The electromagnetic transducer on the flying head slider 24 can thus be positioned right above a target recording track on the magnetic recording disk 14.

A power source such as a voice coil motor, VCM, 25 is connected to the carriage block 17. The voice coil motor 25 serves to drive the carriage block 17 around the vertical support shaft 18. The rotation of the carriage block 17 allows the carriage arms 22 and the head suspensions 23 to swing.

As is apparent from FIG. 1, a flexible printed circuit board unit 26 is placed on the carriage block body 21. The flexible printed circuit board unit 26 includes a head IC (integrated circuit) 28 mounted on a flexible printed wiring board 27. The head IC 28 is designed to supply the read element of the electromagnetic transducer with a sensing current when the magnetic bit data is to be read. The head IC 28 is also designed to supply the write element of the electromagnetic transducer with a writing current when the magnetic bit data is to be written.

A small-sized circuit board is placed within the inner space of the enclosure 12. A printed circuit board, not shown, is attached to the backside of the bottom plate of the base 13. The head IC 28 receives the sensing current and the writing current from the small-sized circuit board or the printed circuit board on the bottom plate through the small-sized circuit board. A flexure 29 is utilized to supply the sensing current and the writing current to the electromagnetic transducer. One end of the flexure 29 is connected to the flexible printed circuit board unit 26. The flexure 29 extends along the side of the corresponding carriage arm 22. The other end of the flexure 29 is attached to the corresponding head suspension 23.

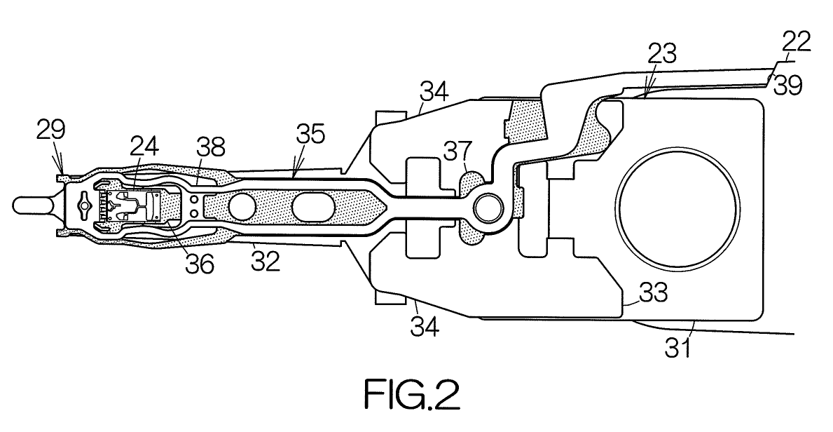

As shown in FIG. 2, the head suspension 23 includes a base plate 31 and a load beam 32. The base plate 31 is attached to the tip end of the carriage arm 22. The load beam 32 is distanced forward from the base plate 31 at a predetermined interval. A hinge plate 33 is fixed to the surfaces of the base plate 31 and the load beam 32. The hinge plate 33 provides an elastic bending section 34 between the front end of the base plate 31 and the rear end of the load beam 32. The hinge plate 33 in this manner serves to couple the base plate 31 with the load beam 32. Each of the base plate 31, the load beam 32 and the hinge plate 33 is made out of a thin plate of stainless steel, for example.

The aforementioned flexure 29 is attached to the front surface of the head suspension 23. The flexure 29 includes a flexure body, namely a stainless steel plate 35. The stainless steel plate 35 includes a support plate 36 and a fixation plate 37. The flying head slider 24 is received on the surface of the support plate 36. The fixation plate 37 is attached to the surfaces of the load beam 32 and the hinge plate 33. Spot welding may be effected at joint spots so as to fix the fixation plate 37, for example. The flying head slider 24 is bonded to the surface of the support plate 36. The support plate 36 and the fixation plate 37 are made out of a single thin plate of stainless steel.

A wiring pattern 38 is formed on the surface of the fixation plate 37. One end of the wiring pattern 38 is connected to the flying head slider 24. The fixation plate 37 extends outward from the contour of the base plate 31 at the side of the base plate 31. The fixation plate 37 extends to the flexible printed circuit board unit 26 along the side of the carriage arm 22 at a position outside the contour of the base plate 31. The fixation plate 37 is received in a groove 39 formed in the side of the carriage arm 22. The head suspension 23 and the flexure 29 thus in combination establish the so-called “long tail structure”. The other end of the wiring pattern 38 is connected to the head IC 28. Electrical connection is thus established between the flying head slider 24 and the head IC 28.

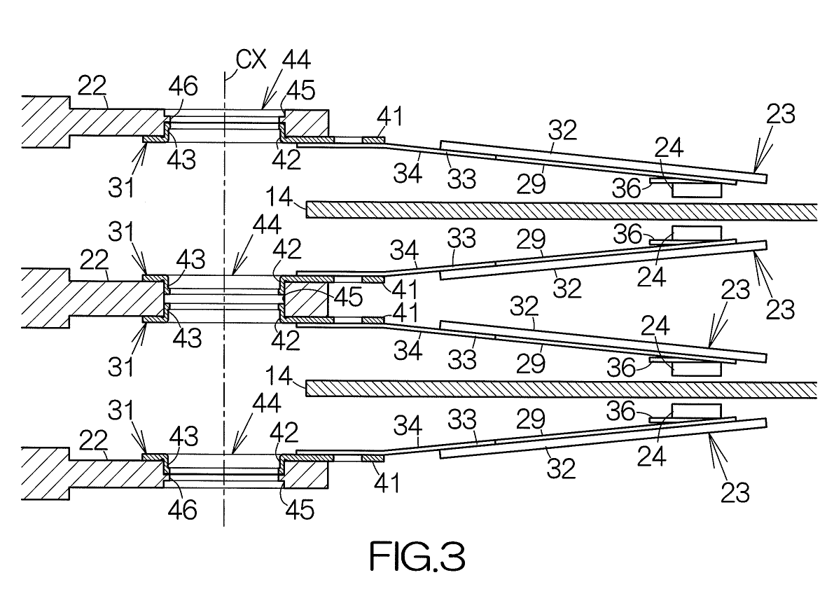

As shown in FIG. 3, the base plate 31 includes a base plate body 41 in the form of a plate. The back surface of the base plate body 41 is received on the carriage arm 22. A cylindrical through hole 42 is formed in the base plate body 41. The through hole 42 penetrates through the base plate body 41 from the front surface to the back surface of the base plate body 41. The base plate 31 includes a boss 43 standing upright from the back surface of the base plate body 41 around the through hole 42. The boss 43 is received in a cylindrical space, namely a caulking hole 44, defined in the tip end of the carriage arm 22. The longitudinal axis CX of the caulking hole 44 extends in parallel with the longitudinal axis of the vertical support shaft 18. The caulking hole 44 penetrates through the carriage arm 22 from the front surface to the back surface of the carriage arm 22. An inward wall surface 45 serves to define the caulking hole 44.

The head suspension 23 is attached to each of the front and back surfaces of the middle one of the carriage arms 22 as described above. A single one of the head suspensions 23 is attached to the back surface of the top one of the carriage arms 22. A single one of the head suspensions 23 is likewise attached to the front surface of the bottom one of the carriage arms 22. The top and bottom ones of the carriage arms 22 include a projection 46 protruding from the inward wall surface 45. The projection 46 protrudes into the caulking hole 44. The projection 46 is formed in an annular shape coaxial with the longitudinal axis CX of the caulking hole 44. The projection 46 is opposed to the boss 43 of the base plate 31.

The support plate 36 is received on a domed swelling, not shown, formed on the surface of the load beam 32 at a position behind the flying head slider 24. The aforementioned elastic bending section 34 is designed to exhibit elasticity or bending force of a predetermined intensity. The bending force is utilized to provide the front end of the load beam 32 with the aforementioned urging force toward the surface of the magnetic recording disk 14. The domed swelling behind the flying head slider 24 serves to apply the urging force to the flying head slider 24. The flying head slider 24 is allowed to enjoy a change in its flying attitude based on the lift generated based on airflow. The domed swelling accepts a change in the attitude of the flying head slider 24, namely the support plate 36.

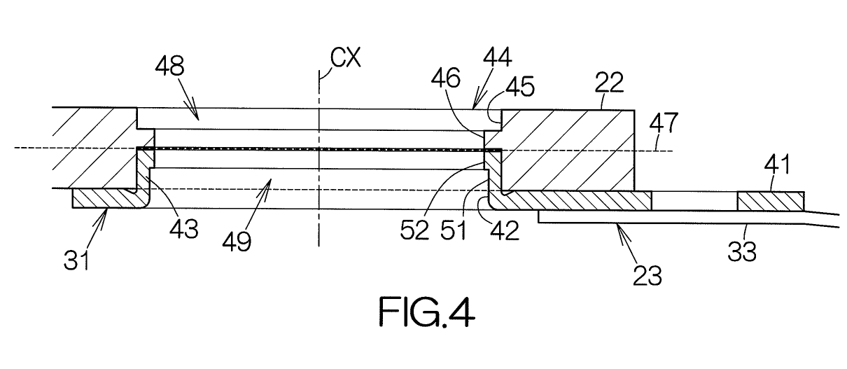

As shown in FIG. 4, an intermediate plane 47 is defined in the top one of the carriage arms 22, for example. The intermediate plane 47 is set perpendicular to the longitudinal axis CX. The intermediate plane 47 divides the caulking hole 44 equally into a first cylindrical space 48 and a second cylindrical space 49. The first cylindrical space 48 is located near the front surface of the carriage arm 22. The second cylindrical space 49 is located near the back surface of the carriage arm 22. The intermediate plane 47 is defined at the intermediate position equally distanced from the front and back surfaces of the carriage arm 22. The aforementioned projection 46 is formed on the inward wall surface 45 at a position off the intermediate plane 47. The projection 46 thus protrudes into the first cylindrical space 48. The projection 46 is formed integral with the inward wall surface 45 of the carriage arm 22.

The boss 43 is placed in the second cylindrical space 49. The boss 43 includes a cylindrical base portion 51 formed continuous with the base plate body 41. The cylindrical base portion 51 endlessly surrounds the through hole 42. The cylindrical base portion 51 stands upright from the back surface of the base plate body 41. An inward annular flange 52 extends inward from the inner surface of the cylindrical base portion 51 at the tip end of the cylindrical base portion 51. The inward annular flange 52 is continuous with the cylindrical base portion 51. The inward annular flange 52 has an inner diameter smaller than the inner diameter of the cylindrical base portion 51. Caulking process serves to apply an urging force of a predetermined intensity to the inward annular flange 52 so that the inward annular flange 52 is urged against the inward wall surface 45, as described later in detail. The head suspension 23 is in this manner attached to the tip end of the carriage arm 22 through the caulking process. It should be noted that mirror symmetry is established between the structure of the top one of the carriage arms 22 and the structure of the bottom one of the carriage arms 22.

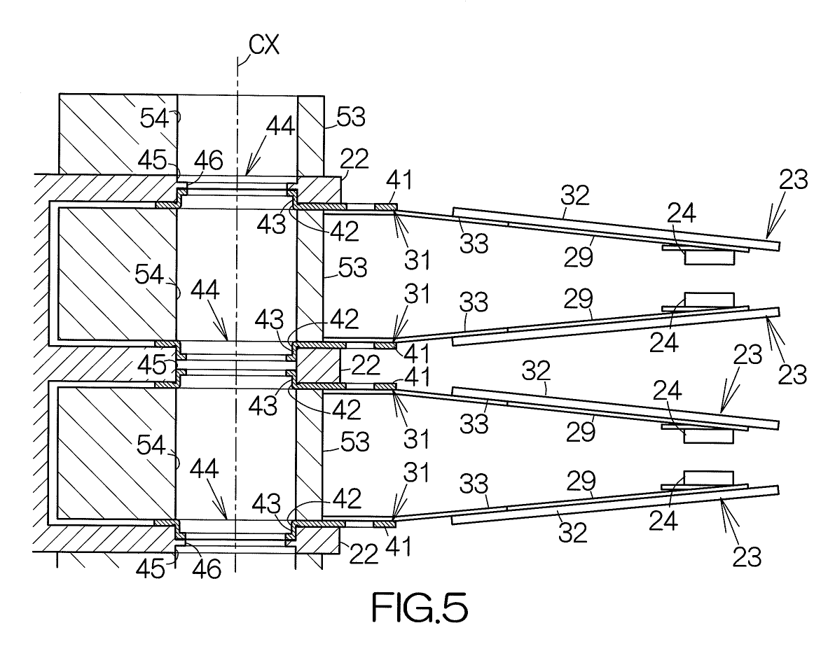

Next, description will be made on a method of making the carriage 16. The head suspensions 23 have already been assembled for the preparation of the production of the carriage 16. The flexure 29 and the flying head slider 24 are fixed to the surface of the head suspension 23. As shown in FIG. 5, the boss 43 is received in the caulking hole 44 in the individual carriage arm 22. The base plate or plates 31 and the corresponding carriage arm 22 are held between the flat surfaces of jigs 53. The jigs 53 serve to urge the base plate body 41 against the front or back surface of the carriage arm 22. A through hole 54 is formed in the individual jig 53. The longitudinal axes of the through holes 54 coincide with the longitudinal axis CX of the caulking hole 44.

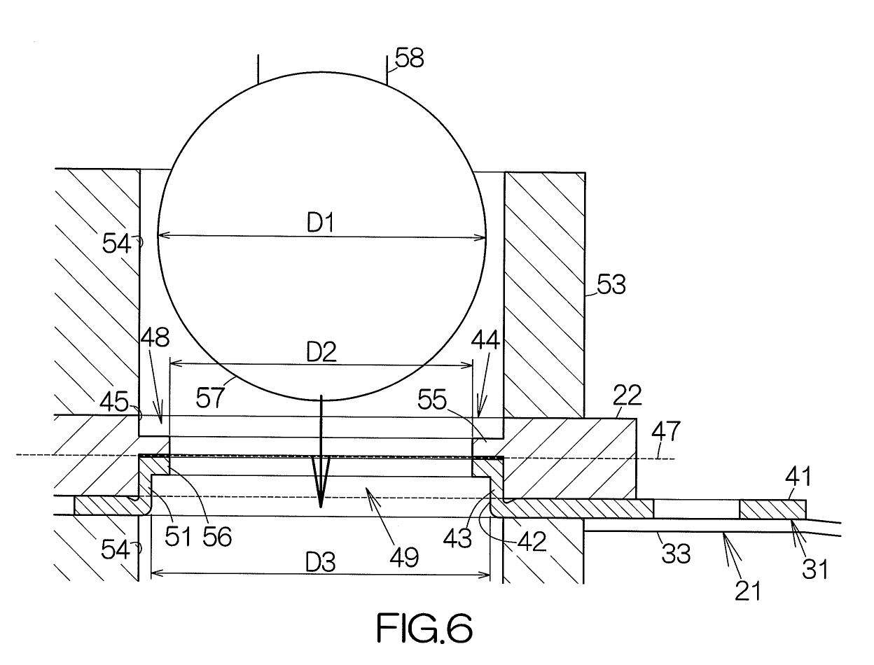

Referring also to FIG. 6, a projection 55 protrudes from the inward wall surface 45 in the top and bottom ones of the carriage arms 22. The projection 55 is formed in an annular shape around the longitudinal axis CX of the caulking hole 44. The projection 55 protrudes into the first cylindrical space 48 at a position off the intermediate plane 47. The boss 43 is placed in the second cylindrical space 49. The boss 43 includes an annular flange 56 continuous with the cylindrical base portion 51. The inner diameter of the projection 55 is set equal to that of the annular flange 56. In this manner, mirror symmetry is established between the projection 55 and the annular flange 56 with respect to the intermediate plane 47. A metallic ball 57 for caulking process is pushed into the caulking hole 44 through the through hole 54 of the jig 53. A caulking pin 58 is utilized to push the metallic ball 57, for example. The outer diameter D1 of the metallic ball 57 is set larger than the inner diameter D2 of the annular flange 56 and the projection 55. It should be noted that the diameter D1 of the metallic ball 57 is set smaller than the inner diameter D3 of the cylindrical base portion 51.

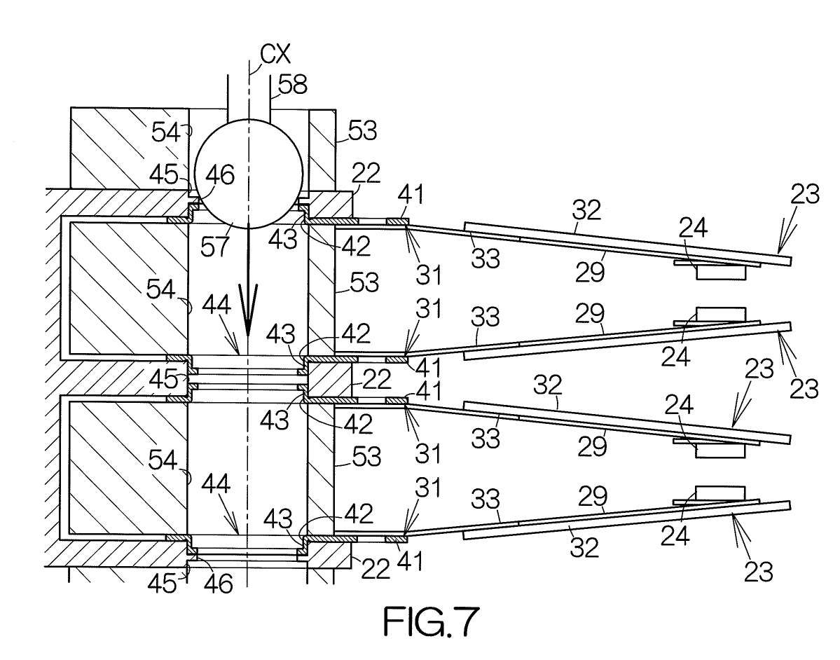

As shown in FIG. 7, when the metallic ball 57 is pushed into the caulking hole 44, the metallic ball 57 contacts with the projection 55 and the annular flange 56 in the top and bottom ones of the carriage arms 22. An urging force is gradually applied to the projection 55 and the annular flange 56 toward the inward wall surface 45. The projection 55 and the annular flange 56 are forced to plastically deform. The annular flange 56 is urged against the inward wall surface 45 with a sufficient intensity. Stress is thus induced in the carriage arm 22 in the radial direction from the longitudinal axis CX in parallel with the intermediate plane 47, for example. The boss 43 is firmly fixed to the caulking hole 44 of the carriage arm 22. The plastic deformation of the projection 55 and the annular flange 56 results in establishment of the aforementioned projection 46 and the aforementioned inward annular flange 52. The head suspensions 23 are in this manner attached to the top and bottom ones of the carriage arms 22 with a high accuracy.

Likewise, when the metallic ball 57 is pushed into the caulking hole 44, the metallic ball 57 contacts with the two annular flanges 56 in the middle one of the carriage arms 22. An urging force is gradually applied to the annular flanges 56 toward the inward wall surface 45. The annular flanges 56 are forced to plastically deform. The annular flanges 56 are urged against the inward wall surface 45 with a sufficient intensity. Stress is thus induced in the carriage arm 22 in the radial direction from the longitudinal axis CX in parallel with the intermediate plane 47, for example. The bosses 43 are firmly fixed to the caulking hole 44 of the carriage arm 22. The plastic deformation of the annular flanges 56 results in establishment of the aforementioned inward annular flanges 52. The head suspensions 23 are in this manner attached to the middle one of the carriage arms 22. Subsequently, one end of the flexure 29 is connected to the flexible printed circuit board unit 26. In this manner, the carriage 16 is produced.

The carriage block 17 includes the top and bottom ones of the carriage arms 22 each having the projection 55 formed on the inward wall surface 45. Mirror symmetry is established between the projection 55 and the annular flange 56 with respect to the intermediate plane 47. When the projection 55 and the annular flange 56 are forced to plastically deform, the carriage arm 22 suffers from stress uniformly resulting from the projection 55 and the annular flange 56 above and below the intermediate plane 47. Deformation of the carriage arm 22 is thus prevented. It should be noted that since the inward annular flanges 52 are symmetrically formed relative to the intermediate plane 47 in the middle one of the carriage arms 22, the carriage arm 22 suffers from stress uniformly resulting above and below the intermediate plane 47. Deformation of the carriage arm 22 is thus prevented. The flying head slider 24 is allowed to fly at a designed flying height.

The projection 55 is made of aluminum in the carriage block 17. The annular flange 56 is made of stainless steel. The Young's modulus of aluminum is one third, approximately, of that of stainless steel. Accordingly, the projection 55 may have a thickness one to three times larger than the thickness of the annular flange 56, approximately. The thickness of the annular flange 56 is defined in parallel with the longitudinal axis of the caulking hole 44. In this manner, the stress is equalized in the carriage arms 22 as much as possible.

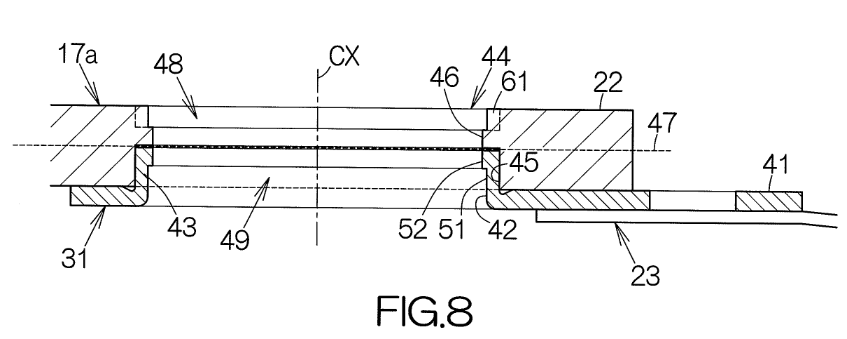

As shown in FIG. 8, a carriage block 17a may be incorporated in the carriage 16 in place of the aforementioned carriage block 17. The top and bottom ones of the carriage arms 22 each have an auxiliary projection 61 formed in the inward wall surface 45 in the carriage block 17a. The auxiliary projection 61 is placed at a position adjacent to the projection 46 between the projection 46 and the opening of the caulking hole 44. The auxiliary projection 61 protrudes into the first cylindrical space 48. Here, the auxiliary projection 61 is formed integral with the projection 46 and the carriage arm 22. The auxiliary projection 61 is formed in an annular shape around the longitudinal axis CX of the caulking hole 44. The inner diameter of the auxiliary projection 61 is set larger than that of the projection 46. The inner diameter of the auxiliary projection 61 is set equal to that of the cylindrical base portion 51. Like reference numerals are attached to the structure or components equivalent to those of the aforementioned carriage block 17.

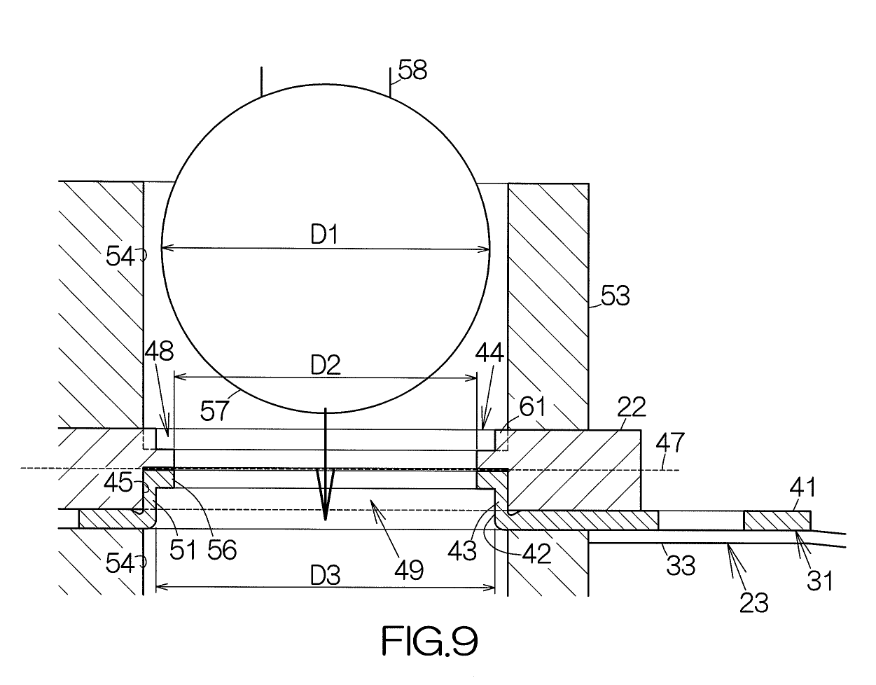

As shown in FIG. 9, the boss 43 is received in the caulking hole 44 in the process of making the carriage 16. The top and bottom ones of the carriage arms 22 each have the projection 55 and the auxiliary projection 61 protruding from the inward wall surface 45. Mirror symmetry is established between the projection 55 and the annular flange 56, as well as between the auxiliary projection 61 and the cylindrical base portion 51, with respect to the intermediate plane 47, respectively. In this situation, the base plate 31 and the carriage arm 22 are interposed between the flat surfaces of the jigs 53 in the same manner as described above. The metallic ball 57 for caulking process is pushed into the caulking hole 44. The diameter D1 of the metallic ball 57 may be set smaller than the inner diameter D3 of the cylindrical base portion 51 and the auxiliary projection 61. The metallic ball 57 causes the projection 55 and the annular flange 56 to plastically deform in the same manner as described above. The plastic deformation of the projection 55 and the annular flange 56 results in establishment of the aforementioned projection 46 and the aforementioned inward annular flange 52. The boss 43 is in this manner firmly fixed to the caulking hole 44.

The top and bottom ones of the carriage arms 22 each have the projection 55 and the auxiliary projection 61 formed on the inward wall surface 45 in the carriage block 17a. Mirror symmetry is established between the projection 55 and the annular flange 56 with respect to the intermediate plane 47 in the same manner as described above. Likewise, mirror symmetry is established between the auxiliary projection 61 and the cylindrical base portion 51 with respect to the intermediate plane 47. When the projection 55 and the annular flange 56 are forced to plastically deform, the carriage arm 22 suffers from stress resulting uniformly from the projection 55 and the annular flange 56 above and below the intermediate plane 47 with a higher reliability. Deformation of the carriage arm 22 is thus prevented with a higher reliability. The flying head slider 24 is allowed to fly at a designed flying height.

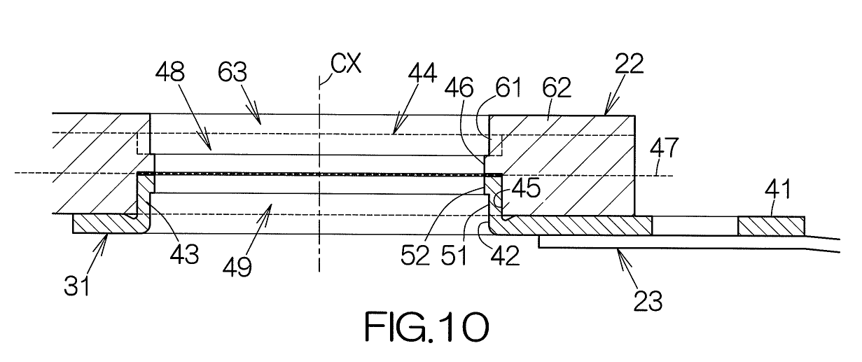

As shown in FIG. 10, a carriage block 17b may be incorporated in the carriage 16 in place of the aforementioned carriage blocks 17, 17a in the carriage 16. A plate-shaped portion 62 is formed in the front surface of the top one of the carriage arms 22, for example, in the carriage block 17b. The plate-shaped portion 62 on the front surface of the carriage arm 22 has a contour identical to the contour of the base plate body 41 defined on the back surface of the carriage arm 22. The thickness of the plate-shaped portion 62 is set equal to that of the base plate body 41. The plate-shaped portion 62 has an inner wall surface 64 surrounding a third cylindrical space 63 continuous with the first cylindrical space 48. The inner wall surface 64 is set continuous with the inner wall surface of the auxiliary projection 61. The plate-shaped portion 62 is formed integral with the carriage arm 22. It should be noted that mirror symmetry is established between the structure of the top one of the carriage arms 22 and the structure of the bottom one of the carriage arms 22. Like reference numerals are attached to the structure or components equivalent to those of the aforementioned carriage block 17a.

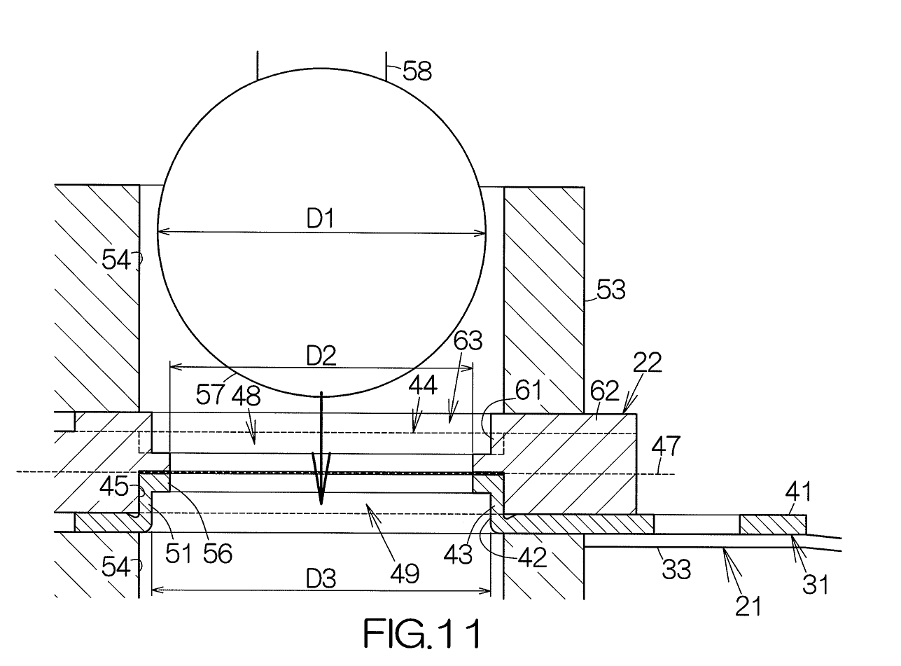

As shown in FIG. 11, the boss 43 is received in the caulking hole 44 in the process of making the carriage 16. The Mirror symmetry is established between the plate-shaped portion 62 and the base plate body 41 with respect to the intermediate plane 47. The metallic ball 57 for caulking process is pushed into the caulking hole 44. When the metallic ball 57 advances in contact with the projection 55 and the annular flange 56, an urging force is applied to the projection 55 and the annular flange 56 toward the inward wall surface 45. The projection 55 and the annular flange 56 are forced to plastically deform. The annular flange 56 is urged against the inward wall surface 45 with a sufficient intensity. The plastic deformation of the projection 55 and the annular flange 56 results in establishment of the aforementioned projection 46 and the aforementioned inward annular flange 52. The boss 43 is in this manner firmly fixed to the caulking hole 44.

The top and bottom ones of the carriage arms 22 each have the projection 55 and the auxiliary projection 61 formed on the inward wall surface 45 in the carriage block 17b. Mirror symmetry is established between the projection 55 and the annular flange 56 with respect to the intermediate plane 47. Mirror symmetry is likewise established between the auxiliary projection 61 and the cylindrical base portion 51 with respect to the intermediate plane 47. Mirror symmetry is also established between the plate-shaped portion 62 and the base plate body 41 with respect to the intermediate plane 47. When the projection 55 and the annular flange 56 are forced to plastically deform, the carriage arm 22 suffers from stress uniformly above and below the intermediate plane 47 with a higher reliability. Deformation of the carriage arm 22 is thus prevented with a higher reliability. The flying head slider 24 is allowed to fly at a designed flying height.

Although the aforementioned embodiments relate to a magnetic storage apparatus for recording of information data in a magnetic recording disk, the present invention cannot be limited to application to such a storage medium drive. The present invention can also be applied to an optical storage apparatus for recording/reproduction of information data in/from an optical disk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has been described in detail, it should be understood that the various changes, substitutions, and alterations could be made hereto without departing from the spirit and scope of the invention.

What is claimed is:

1. A storage apparatus comprising:
a carriage block body coupled to a support shaft for relative rotation, the carriage block body defining a bearing hole receiving the support shaft;
a carriage arm extending from the carriage block body along an imaginary plane perpendicular to a longitudinal axis of the support shaft, the carriage arm having a wall surface defining a cylindrical space at a tip end of the carriage arm; and
a projection formed on the wall surface at a position off an intermediate plane, the intermediate plane set perpendicular to a longitudinal axis of the cylindrical space so as to equally divide the cylindrical space into a first cylindrical space and a second cylindrical space, the projection protruding into the first cylindrical space.

2. The storage apparatus according to claim 1, wherein the projection is formed in an annular shape around the longitudinal axis of the cylindrical space.

3. The storage apparatus according to claim 2, further comprising an auxiliary projection formed on the wall surface at a position adjacent to the projection between the projection and an opening of the cylindrical space, the auxiliary projection protruding into the first cylindrical space.

4. The storage apparatus according to claim 3, wherein the auxiliary projection is formed in an annular shape around the longitudinal axis of the cylindrical space.

5. The storage apparatus according to claim 4, wherein an inner diameter of the auxiliary projection is set larger than an inner diameter of the projection.

6. The storage apparatus according to claim 5, further comprising a plate-shaped portion formed in the carriage arm, the plate-shaped portion having a further wall surface continuous with the wall surface, the further wall surface defining a third cylindrical space as an extension of the first cylindrical space.

7. The storage apparatus according to claim 6, wherein the plate-shaped portion is formed integral with the carriage arm.

8. The storage apparatus according to claim 3, further comprising a plate-shaped portion formed in the carriage arm, the plate-shaped portion having a further wall surface continuous with the wall surface, the further wall surface defining a third cylindrical space as an extension of the first cylindrical space.

9. The storage apparatus according to claim 8, wherein the plate-shaped portion is formed integral with the carriage arm.

10. The storage apparatus according to claim 1, further comprising an auxiliary projection formed on the wall surface at a position adjacent to the projection between the projection and an opening of the cylindrical space, the auxiliary projection protruding into the first cylindrical space.

11. The storage apparatus according to claim 10, further comprising a plate-shaped portion formed in the carriage arm, the plate-shaped portion having a further wall surface continuous with the wall surface, the further wall surface defining a third cylindrical space as an extension of the first cylindrical space.

12. The storage apparatus according to claim 11, wherein the plate-shaped portion is formed integral with the carriage arm.
